(19) United States
(12) Patent Application Publication
(10) Pub. No.: US 2026/0005615 A1
(43) Pub. Date: Jan. 1, 2026

(54) POWER CIRCUIT, POWER CONTROL METHOD, COMPOUND POWER CIRCUIT AND ELECTRONIC DEVICE

(71) Applicant: SHENZHEN MEGMEET ELECTRICAL CO., LTD., Shenzhen (CN)

(72) Inventors: Longfei HAN, Shenzhen (CN); Zhong WANG, Shenzhen (CN); Chuchun SHEN, Shenzhen (CN); Chung Hei Albert POON, Shenzhen (CN); Qiong WU, Shenzhen (CN); Xiaoming LIU, Shenzhen (CN); Lu ZHANG, Shenzhen (CN); Kelei WANG, Shenzhen (CN)

(73) Assignee: SHENZHEN MEGMEET ELECTRICAL CO., LTD., Shenzhen (CN)

(21) Appl. No.: 19/026,194

(22) Filed: Jan. 16, 2025

(30) Foreign Application Priority Data
Jun. 28, 2024 (CN) 202410854319.4

(51) Int. Cl. H02M 3/335; H02M 1/00; H02M 1/088; H02M 1/12; H02M 1/14; H02M 1/44

(52) U.S. Cl. CPC H02M 3/33573; H02M 1/0064; H02M 1/088; H02M 1/12; H02M 1/14; H02M 1/44; H02M 3/33592

(57) ABSTRACT

A power circuit, a power control method, a compound power circuit and an electronic device are provided. The power circuit includes an inverter circuit for converting a first DC signal of the DC power source to a first AC signal, a resonant circuit for regulating the first AC signal, an isolation transformer for converting the regulated first AC signal to a second AC signal, a rectifier circuit for converting the second AC signal to a second DC signal and outputting the second DC signal to a load circuit, and a control circuit for generating a first control signal based on rise and/or drop of the first AC signal voltage and/or rise and/or drop of the second AC signal voltage; the rectifier circuit regulates the second DC signal based on the first control signal.

### CROSS-REFERENCE TO RELATED APPLICATION

The present application claims the benefit of priority to Chinese Patent Application No. 202410854319.4, filed on Jun. 28, 2024, which is hereby incorporated by reference in its entirety.

### TECHNICAL FIELD

The embodiments of this application relate to a power technology field, and more particularly, to a power circuit, a power control method, a compound power circuit and an electronic device.

### TECHNICAL BACKGROUND

With the rapid development of various electronic products, especially with the advent of the cloud computing and big data era, the application of servers has increased sharply, bringing higher requirements for power systems with high efficiency, high power density and low noises. In power systems, pulse width modulation (PWM) converters are common devices to achieve power control.

However, traditional PWM converters have bottlenecks in improving efficiency and power density because soft switching is difficultly realized, circuit losses are high and switching noises are high.

### SUMMARY

The embodiments of this application provide a power circuit, a power control method, a compound power circuit and an electronic device which can solve the problem that power circuits in the related art have bottlenecks in improving efficiency and power density because circuit losses and switching noises are high in the related art.

A technical scheme of the application for solving the above technical problems is to provide a power circuit, wherein, the power circuit includes: an inverter circuit for coupling with a DC power source to receive a first DC signal from the DC power source and convert the first DC signal to a first AC signal; a resonant circuit coupled with the inverter circuit to receive and regulate the first AC signal from the inverter circuit; an isolation transformer coupled with the resonant circuit to receive the regulated first AC signal from the resonant circuit and convert the regulated first AC signal to a second AC signal; a rectifier circuit coupled with the isolation transformer and for coupling with a load circuit to receive the second AC signal from the isolation transformer, convert the second AC signal to a second DC signal and output the second DC signal to the load circuit; a control circuit coupled with the inverter circuit and the rectifier circuit to obtain the first AC signal and/or the second AC signal in the isolation transformer by sampling and generate a first control signal based on rise and/or drop of the first AC signal voltage and/or rise and/or drop of the second AC signal voltage; and the rectifier circuit receives the first control signal and regulates the second DC signal based on the first control signal.

Wherein, the control circuit also obtains the second DC signal in the rectifier circuit by sampling, compares the second DC signal with a preset power threshold to determine the signal frequency of a second control signal and sends the second control signal at the signal frequency; and the inverter circuit receives the second control signal and regulates the first AC signal based on the second control signal.

Wherein, the inverter circuit includes a first switch sub-circuit and a second switch sub-circuit; the first switch sub-circuit is coupled with the second switch sub-circuit, the resonant circuit, the isolation transformer and the control circuit and is for coupling with the DC power source; the second switch sub-circuit is coupled with the control circuit; the second control signal includes a first drive signal and a second drive signal; wherein, the first switch sub-circuit receives the first drive signal to change the switch state under the action of the first drive signal; the second switch sub-circuit receives the second drive signal to change the switch state under the action of the second drive signal to match with the switch state of the first switch sub-circuit, and regulates the first AC signal.

Wherein, the control circuit includes a sampling circuit, a signal processing circuit and a drive circuit; the sampling circuit is coupled with the isolation transformer and the signal processing circuit, the signal processing circuit is coupled with the drive circuit, and the drive circuit is coupled with the inverter circuit and the rectifier circuit; the sampling circuit obtains the first AC signal and/or the second AC signal in the isolation transformer by sampling; and the signal processing circuit receives the first AC signal and/or the second AC signal, controls the drive circuit to change the level state of the first control signal by responding to rise and/or drop of the first AC signal voltage and/or rise and/or drop of the second AC signal voltage, and sends the first control signal to the rectifier circuit to trigger the rectifier circuit to change the switch state and regulate the second DC signal.

Wherein, the control circuit also includes a first proportional filtering correction circuit and a second proportional filtering correction circuit, and the sampling circuit includes a first sampling circuit and a second sampling circuit; the first sampling circuit is coupled with the isolation transformer and the first proportional filtering correction circuit; the second sampling circuit is coupled with the rectifier circuit and the second proportional filtering correction circuit; wherein, the first sampling circuit obtains the first AC signal and/or the second AC signal in the isolation transformer by sampling; the second sampling circuit obtains the second DC signal in the rectifier circuit by sampling; the first proportional filtering correction circuit receives the first AC signal and/or the second AC signal, and sends the first AC signal and/or the second AC signal to the signal processing circuit after comparison with reference value, filtration and correction, so that the signal processing circuit controls the drive circuit to generate the third drive signal and the fourth drive signal; and the second proportional filtering correction circuit receives the second DC signal, and sends the second DC signal to the signal processing circuit after comparison with reference value, filtration and correction, so that the signal processing circuit controls the drive circuit to generate the first drive signal and the second drive signal.

Wherein, the rectifier circuit includes a third switch sub-circuit and a fourth switch sub-circuit, and the isolation transformer includes a primary winding and a secondary winding; the primary winding is coupled with the resonant circuit and the secondary winding, the secondary winding is coupled with the third switch sub-circuit, the fourth switch sub-circuit and the sampling circuit, the third switch sub-circuit is coupled with the fourth switch sub-circuit and the control circuit and is for coupling with the load circuit, and the fourth switch sub-circuit is coupled with the control circuit; the first control signal includes a third drive signal and a fourth drive signal, and the second AC signal includes the first current signal of the third switch sub-circuit and the second current signal of the fourth switch sub-circuit; wherein, the primary winding receives the regulated first AC signal from the resonant circuit and the secondary winding converts the first AC signal to the second AC signal, and sends the second AC signal to the third switch sub-circuit and the fourth switch sub-circuit; the first AC signal includes the first voltage signals on both ends of the primary winding and the second AC signal includes the second voltage signals on both ends of the secondary winding; the third switch sub-circuit receives the third drive signal from the control circuit; the third drive signal changes the level state in rise and drop of the first voltage signal and/or in rise and drop of the second voltage signal to trigger the third switch sub-circuit to change the switch state; and the fourth switch sub-circuit receives the fourth drive signal; the fourth drive signal changes the level state in rise and drop of the first voltage signal and/or in rise and drop of the second voltage signal to trigger the fourth switch sub-circuit to change the switch state.

Wherein, the second AC signal also includes a first current signal of the third switch sub-circuit and a second current signal of the fourth switch sub-circuit; the control circuit regulates the first level state of the third drive signal to the second level state when the first voltage signal and/or the second voltage signal rise/rises, and the control circuit regulates the second level state of the third drive signal to the first level state when the first voltage signal and/or the second voltage signal drop/drops, or when the first current signal attenuates to 0 forward; and the control circuit regulates the first level state of the fourth drive signal to the second level state when the first voltage signal and/or the second voltage signal drop/drops, and the control circuit regulates the second level state of the fourth drive signal to the first level state when the first voltage signal and/or the second voltage signal rise/rises, or when the second current signal attenuates to 0 forward.

Wherein, when the signal frequency is lower than the resonant frequency of the resonant circuit, the first drive signal is in the second level state, the second drive signal is in the first level state, the third drive signal is in the first level state and the fourth drive signal is in the second level state, and/or, when the first drive signal is in the first level state, the second drive signal is in the second level state, the third drive signal is in the second level state and the fourth drive signal is in the first level state, the phase of the third current of the resonant circuit remains unchanged.

Wherein, the first switch sub-circuit includes a first switching tube and a fourth switching tube, and the second switch sub-circuit includes a second switching tube and a third switching tube; wherein, the first end of the first switching tube is coupled with the first end of the third switching tube and is for coupling with the first end of the DC power source, the second end of the first switching tube is coupled with the first end of the second switching tube and the first end of the resonant circuit, the second end of the third switching tube is coupled with the first end of the fourth switching tube and the second end of the isolation transformer, the second end of the second switching tube is coupled with the second end of the fourth switching tube and is for coupling with the second end of the DC power source, and the third ends of the first switching tube, the second switching tube, the third switching tube and the fourth switching tube are coupled with the control output end of the control circuit; or, the first switch sub-circuit includes a seventh switching tube, and the second switch sub-circuit includes an eighth switching tube; wherein, the first end of the seventh switching tube is for coupling with the first end of the DC power source, the second end of the seventh switching tube is coupled with the first end of the eighth switching tube and the first end of the resonant circuit, the second end of the eighth switching tube is coupled with the second end of the isolation transformer and is for coupling with the second end of the DC power source, and the third end of the seventh switching tube and the third end of the eighth switching tube are coupled with the control output end of the control circuit.

Wherein, the secondary winding includes a first sub secondary winding and a second sub secondary winding, the third switch sub-circuit includes a fifth switching tube, and the fourth switch sub-circuit includes a sixth switching tube; wherein, the first end of the first sub secondary winding is coupled with the first end of the fifth switching tube, the second end of the first sub secondary winding is coupled with the second end of the second sub secondary winding and is for coupling with the second end of the load circuit, the first end of the second sub secondary winding is coupled with the first end of the sixth switching tube, the second end of the fifth switching tube is coupled with the second end of the sixth switching tube and is for coupling with the first end of the load circuit, and the third end of the fifth switching tube and the third end of the sixth switching tube are coupled with the control output end of the control circuit; or, the third switch sub-circuit includes a ninth switching tube and a twelfth switching tube, and the fourth switch sub-circuit includes a tenth switching tube and an eleventh switching tube; wherein, the first end of the secondary winding is coupled with the first end of the ninth switching tube and the second end of the tenth switching tube, the second end of the secondary winding is coupled with the first end of the eleventh switching tube and the second end of the twelfth switching tube, the second end of the ninth switching tube is coupled with the second end of the eleventh switching tube and is for coupling with the first end of the load circuit, the first end of the tenth switching tube is coupled with the first end of the twelfth switching tube and is for coupling with the second end of the load circuit, and the third ends of the ninth switching tube, the tenth switching tube, the eleventh switching tube and the twelfth switching tube are coupled with the control output end of the control circuit.

Another technical scheme of the application for solving the above technical problems is to provide a power control method. The power control method includes receiving the first DC signal from the DC power source; converting the first DC signal to the first AC signal; regulating the first AC signal; converting the regulated first AC signal to the second AC signal; converting the second AC signal to the second DC signal and outputting the second DC signal to the load circuit; generating the first control signal based on rise and/or drop of the regulated first AC signal voltage and/or rise and/or drop of the second AC signal voltage; and regulating the second DC signal based on the first control signal.

Wherein, besides the step of converting the second AC signal to the second DC signal and outputting the second DC signal to the load circuit, the power control method also includes: comparing the second DC signal with the preset power threshold to determine the signal frequency of the second control signal; and regulating the first AC signal based on the second control signal.

Wherein, the first control signal includes the third drive signal and the fourth drive signal, and the second AC signal includes the first voltage signal, the second voltage signal, the first current signal and the second current signal; the step of generating the first control signal based on rise and/or drop of the regulated first AC signal voltage and/or rise and/or drop of the second AC signal voltage includes: regulating the first level state of the third drive signal to the second level state when the first voltage signal and/or the second voltage signal rise/rises; regulating the second level state of the third drive signal to the first level state when the first voltage signal and/or the second voltage signal drop/drops, or when the first current signal attenuates to 0 forward; regulating the first level state of the fourth drive signal to the second level state when the first voltage signal and/or the second voltage signal drop/drops; and regulating the second level state of the fourth drive signal to the first level state when the first voltage signal and/or the second voltage signal rise/rises, or when the second current signal attenuates to 0 forward.

Another technical scheme of the application for solving the above technical problems is to provide a compound power circuit, wherein, the compound power circuit includes a DC power source and two or more power circuits which are in series or parallel connection and are coupled with the DC power source; wherein, the power circuit is the one mentioned above.

Another technical scheme of the application for solving the above technical problems is to provide an electronic device, wherein, the electronic device includes a shell, and a power circuit or a compound power circuit connected with the shell; wherein, the power circuit is the power circuit mentioned above or the compound power circuit mentioned above.

The beneficial effects of this application are that different from the related art, in this application, the inverter circuit receives the first DC signal from the DC power source and converts the first DC signal to the first AC signal, the resonant circuit regulates the first AC signal, the isolation transformer converts the regulated first AC signal to the second AC signal, and the rectifier circuit converts the second AC signal to the second DC signal and outputs the second DC signal to the load circuit; wherein, the control circuit generates the first control signal based on rise and/or drop of the first AC signal voltage and/or rise and/or drop of the second AC signal voltage, and sends the first control signal to the rectifier circuit to trigger the rectifier circuit to change the switch state under the action of the first control signal and regulate the second DC signal; the isolation transformer regulates the current of the resonant circuit. Embodiments in this application ensure the realization of the inverter circuit Zero Voltage Switch (ZVS) ON, and guarantee high efficiency and high reliability of the power circuit within the full frequency working range, effectively reducing circuit losses and switching noises, expanding the maximum gain range and improving the efficiency and power density of power circuits for wide application.

### BRIEF DESCRIPTION OF DRAWINGS

To provide an explanation of the technical schemes in the embodiments of this application, a brief introduction will be given to the drawings required in the description of the embodiments.

Obviously, the drawings in the following description are only some embodiments of the application. A person skilled in the art can obtain other drawings based on these drawings without putting in creative labor. Wherein:

FIG. 1 illustrates a structural schematic diagram of the first embodiment of the power circuit in this application;

FIG. 2 illustrates a structural schematic diagram of the second embodiment of the power circuit in this application;

FIG. 3a. illustrates an equivalent circuit diagram of the resonant circuit in mode 1 in FIG. 2;

FIG. 3b. illustrates an equivalent circuit diagram of the resonant circuit in mode 2 in FIG. 2;

FIG. 3c. illustrates an equivalent circuit diagram of the resonant circuit in mode 3 in FIG. 2;

FIG. 3d. illustrates an equivalent circuit diagram of the resonant circuit in mode 4 in FIG. 2;

FIG. 4a. illustrates a waveform diagram of sampling signals and control signals when the signal frequency of the second control signal from the control circuit is higher than the resonant frequency of the resonant circuit in FIG. 2;

FIG. 4b. illustrates a waveform diagram of sampling signals and control signals when the signal frequency of the second control signal from the control circuit is equal to the resonant frequency of the resonant circuit in FIG. 2;

FIG. 4c. illustrates a waveform diagram of sampling signals and control signals when the signal frequency of the second control signal from the control circuit is lower than the resonant frequency of the resonant circuit in FIG. 2;

FIG. 5. illustrates a structural schematic diagram of another embodiment of the inverter circuit of the power circuit in FIG. 2;

FIG. 6. illustrates a structural schematic diagram of another embodiment of the rectifier circuit of the power circuit in FIG. 2;

FIG. 7. illustrates a process schematic diagram of an embodiment of the power control method in this application;

FIG. 8. illustrates a process diagram of an embodiment of S36 in FIG. 7;

FIG. 9. illustrates a framework diagram of an embodiment of the compound power circuit in this application; and

FIG. 10. illustrates a framework diagram of an embodiment of the electronic device in this application.

### DETAILED DESCRIPTION

The following will provide a description of the technical schemes of the embodiments in this application by combining with the drawings. Obviously, the described embodiments are only a portion of the embodiments in this application, and not all. Based on the embodiments in this application, all other embodiments obtained by a person skilled in the art without putting in creative labor are within the protection scope of this application.

In this application, the terms “first,” “second” and “third” are only for describing the purpose and may not be understood as indicating or implying relative importance or implying the number of technical features. Therefore, the “first,” “second” and “third” feature can explicitly or implicitly include one or more features. In the description of this application, the term “a plurality of” means two or more, unless otherwise specified. In addition, the terms “include,” “comprise” and any other variants are intended to cover non-exclusive inclusion. For example, a series of steps or units included in a process, a method, a system, a product or a device are not limited to the listed steps or units, but in some embodiments, may include steps or units that are not listed, or may include other steps or units inherent to the process, the method, the system, the product or the device.

The term “embodiment” in this application means that specific features, structures or characteristics described by combining the embodiments may be included in one or more embodiments in this application. The term “embodiment” in different positions in the specifications is not necessarily the same embodiment, nor an independent or alternative embodiment that is exclusive with other embodiments. A person skilled in the art explicitly and implicitly understands that the embodiments in this application may be combined with other embodiments.

A detailed explanation of this application will be provided in combining with the drawings and embodiments as follow.

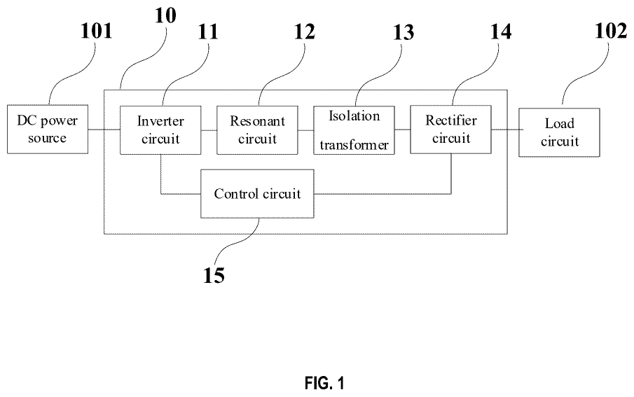

Referring to FIG. 1, FIG. 1 illustrates a structural schematic diagram of the first embodiment of the power circuit in this application. In this embodiment, a power circuit 10 includes an inverter circuit 11, a resonant circuit 12, an isolation transformer 13, a rectifier circuit 14 and a control circuit 15.

Wherein, in some embodiments, the power circuit 10 in this application is applied in the power supply to a load circuit 102 which needs the DC output, converts the DC power from a DC power source 101 to the AC power, and then converts the AC power to the DC power which is provided to the load circuit 102 in any reasonable electronic devices, such as servers, computers and intelligent communication devices, with higher requirements for efficiency, power density and noise. There is no relevant limitation in this embodiment.

It is worth noting that in some embodiments, the DC power source 101 may be understood as a battery with DC output, a DC voltage stabilizer or any other DC power sources, or DC power output after conversion and regulation of grid power supply, PV power supply, independent generator power supply or any other reasonable superior power supply. The load circuit 102 may be understood as a signal function circuit which operates with the DC output from the power circuit 10.

Furthermore, the term “coupling” in this application refers to any direct and indirect means of connection. Therefore, the description that the first circuit is coupled with the second circuit in the application means that the first circuit may be directly connected to the second circuit by electrical connection or signal connection such as wireless transmission and optical transmission, or indirectly connected to the second circuit through other circuits or connection means by electrical connection or signal connection.

In some embodiments, the inverter circuit 11 is for physical and electrical connection with the DC power source 101 to receive a first DC signal with constant current and/or voltage from the DC power source 101, and to quickly switch the DC power by a switch action mechanism, such as an IGBT, a high-frequency transistor, a MOS and other switching devices, to generate the alternating voltage wave and obtain the first AC signal under the signal control.

Wherein, the resonant circuit 12 is directly connected with the inverter circuit 11 to receive a first AC signal from the inverter circuit 11, and regulate the first AC signal by one or a plurality of any reasonable signal regulation methods, such as filtering shaping and phase shifting, so as to achieve better output characteristics and to bring more stable and more efficient power to the subsequent links, such as the rectifier circuit or the load.

The isolation transformer 13 is coupled with the resonant circuit 12 to receive the regulated first AC signal from the resonant circuit 12, and convert the regulated first AC signal to the second AC signal; the electromagnetic connection replaces electrical connection to realize electrical isolation and voltage matching between the primary side and the secondary side to meet the requirements for the primary side and the secondary side in safety regulations.

The rectifier circuit 14 is coupled with the isolation transformer 13 and is for coupling with the load circuit 102, and involves transformer isolation and rectification. In some embodiments, the rectifier circuit 14 receives the second AC signal from the isolation transformer 13, realizes stable DC output, i.e., the second DC signal, based on the second AC signal by high frequency rectification technologies, such as PWM, synchronous rectification, inverse damping rectification and one of any other reasonable rectification methods, and outputs the second DC signal to the load circuit 102 to supply power.

The control circuit 15 is coupled with the inverter circuit 11 and the rectifier circuit 14 by electrical connection and/or communication connection to regulate the switch state of the inverter circuit 11 and the rectifier circuit 14 so as to regulate the signal output of the inverter circuit 11 and the rectifier circuit 14.

In some embodiments, the control circuit 15 obtains the first AC signal and/or the second AC signal from the isolation transformer 13 by sampling and generates the first control signal based on rise and/or drop of the first AC signal voltage and/or rise and/or drop of the second AC signal voltage.

It is worth noting that the first AC signal may be understood as the voltage and current signal of the primary side of the isolation transformer 13, while the second AC signal may be understood as the voltage and current signal of the secondary side of the isolation transformer 13, i.e., the first AC signal voltage and the second AC signal voltage rise or drop synchronously. Therefore, the sampling purposes of the control circuit 15 to changes of the first AC signal voltage and the second AC signal voltage are the same, i.e., to obtain the voltage change of winding of the isolation transformer 13. Only the first AC signal voltage or the second AC signal voltage may be sampled. To ensure the stability and effectiveness of the sampling results for mutual verification, both the first AC signal voltage and the second AC signal voltage may be sampled.

Furthermore, rise and/or drop of the first AC signal voltage refer/refers to that the first AC signal voltage has a rise state and a drop state, i.e., there is a rise edge and a drop edge in the waveform of the first AC signal voltage, instead of the simultaneous rise and drop of the first AC signal voltage; similarly, rise and/or drop of the second AC signal voltage refer/refers to that the second AC signal voltage has a rise state and a drop state or the second AC signal has two voltage signals, both voltage signals have a rise state and a drop state, and when one voltage signal rises, the other drops, while when one voltage signal drops, the other rises; it may be understood that in some embodiments, the control circuit 15 generates the first control signal by responding to one or a plurality of states, i.e., rise of the first AC signal voltage, drop of the first AC signal voltage, rise of the second AC signal voltage and drop of the second AC signal voltage. However, the present disclosure is not limited to the embodiments described herein.

The rectifier circuit 14 also receives the first control signal from the control circuit 15, changes the switch state under the action of the first control signal and regulates the second DC signal; the isolation transformer 13 regulates the current of the resonant circuit 12; for example, before the change of the switch state of the inverter circuit 11, the phase of the current of the resonant circuit 12 remains unchanged to ensure the inverter circuit ZVS ON and OFF.

In some embodiments, the control circuit 15 may include one of any reasonable circuit units with signal processing functions, such as a control chip, a MCU circuit, a CPU, a single-chip computer, a field programmable gate array, a programmable logic controller, a discrete gate or a transistor logic device and a piece of discrete hardware. However, the present disclosure is not limited to the embodiments described herein.

The above scheme regulates the switch state of the rectifier circuit 14 by responding to the change of the first AC signal voltage and/or the second AC signal to effectively ensure the inverter circuit 11 ZVS ON, and ensure high efficiency and high reliability in the full frequency working range of the power circuit 10. Therefore, above scheme effectively reduces circuit losses and switch noises, expands the maximum gain range of the power circuit 10 and improves efficiency and power density of the power circuit 10 for wide application.

It is worth noting that ZVS is a common soft switching technology in switching power sources. ZVS reduces the voltage to zero before the switching tube is ON so as to realize zero voltage ON and reduce switch losses and electromagnetic interference.

In an embodiment, the control circuit 15 also obtains the second DC signal to the load circuit 102 from the rectifier circuit 14 by sampling, compares the current second DC signal with the preset power threshold to determine the signal frequency of the second control signal based on the difference between the second DC signal and the preset power threshold, and sends the second control signal to the inverter circuit 11 at the determined signal frequency to trigger the inverter circuit 11 to regulate the switch state, and to regulate the first AC signal from the inverter circuit 11 and the second DC signal.

It is worth noting that the second DC signal includes the current signal and the voltage signal; in some embodiments, the preset power threshold may be understood as the target power supply demand of the load circuit 102, such as the target set value of required voltage, current or power output of the power source of the load circuit 102, and may also be understood as the preset target power supply signal. In some embodiments, the control circuit 15 dynamically regulates the signal frequency of the second control signal based on the difference between the second DC signal and the preset power threshold; for example, when the second DC signal is lower than the preset power threshold, increase the signal frequency of the second control signal, and when the second DC signal is higher than the preset power threshold, reduce the signal frequency of the second control signal until reaching the target set value of voltage, current or power, i.e., within the preset power threshold range, and determine the signal frequency of the second control signal in a stable state.

It may be understood that the control circuit 15 not only optimizes the control efficiency of the inverter circuit 11 by accurate frequency matching, but also ensures the stable frequency of a harmonic oscillation circuit as well as the inverter circuit 11 ZVS ON and OFF so as to effectively ensure the efficient and stable power supply of the whole power circuit 10.

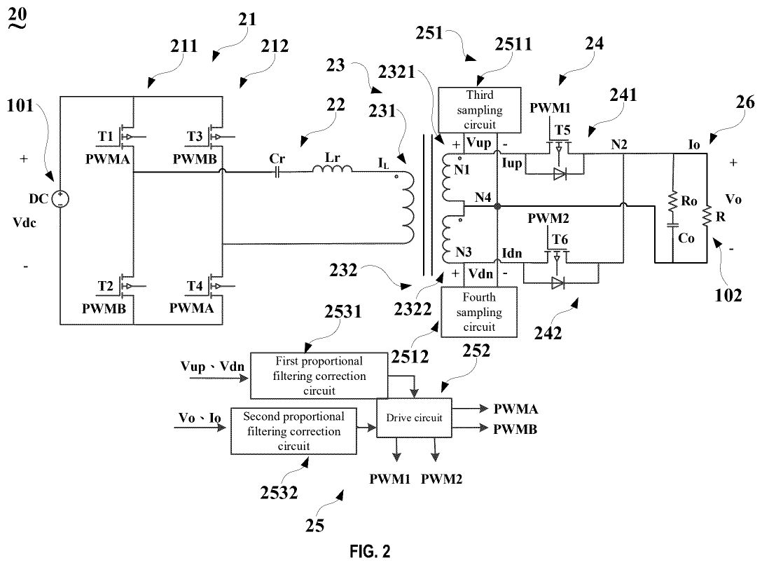

Referring to FIG. 2, FIG. 2 illustrates a structural schematic diagram of the second embodiment of the power circuit in this application. The difference between the power circuit in this embodiment and the first embodiment of the power circuit in this application is that, the inverter circuit 21 of the power circuit 20 also further includes a first switch sub-circuit 211 and a second switch sub-circuit 212.

In some embodiments, the first switch sub-circuit 211 is coupled with the second switch sub-circuit 212, the resonant circuit 22, the isolation transformer 23 and the control circuit 25, and is for coupling with the DC power source 101; the second switch sub-circuit 212 is coupled with the control circuit 25.

Wherein, the second control signal also further includes a first drive signal PWMA and a second drive signal PWMB, the first drive signal PWMA and the second drive signal PWMB have opposite phases, i.e., the two have opposite level states; when the first drive signal PWMA is in the first level state, the second drive signal PWMB is in the second level state; when the first drive signal PWMA is in the second level state, the second drive signal PWMB is in the first level state; the first drive signal PWMA and the second drive signal PWMB have the same signal frequency which is determined by comparing the second DC signal obtained by the control circuit 25 by sampling and the preset power threshold.

It is worth noting that in some embodiments, the first level state may be corresponding to a low level or zero level, while the second level state may be corresponding to a high level; or in some embodiments, the first level state may be corresponding to a high level, while the second level state may be corresponding to a low level or zero level.

Further, the first switch sub-circuit 211 receives the first drive signal PWMA and controls switching time of the internal switch state by responding to the level change of the first drive signal PWMA to trigger the first switch sub-circuit 211 to change the switch state.

The second switch sub-circuit 212 receives the second drive signal PWMB and controls switching time of the internal switch state by responding to the level change of the second drive signal PWMB to trigger the second switch sub-circuit 212 to change the switch state to match with the switch state of the first switch sub-circuit 211, regulates the first AC signal, and triggers the change of the switch state when the voltage drops to zero to minimize switch losses, improve efficiency and reduce electromagnetic interference.

In an embodiment, the control circuit 25 also further includes a sampling circuit 251, a signal processing circuit (not marked in the drawing) and a drive circuit 252; the sampling circuit 251 is coupled with the isolation transformer 23 and the signal processing circuit, the signal processing circuit is coupled with the drive circuit 252 and the drive circuit 252 is coupled with the inverter circuit 21 and the rectifier circuit 24.

Wherein, the sampling circuit 251 obtains the first AC signal and/or the second AC signal from the isolation transformer 23.

The signal processing circuit receives the first AC signal and/or the second AC signal and regulates the internal parameters by responding to rise and/or drop of the first AC signal voltage and/or the second AC signal voltage so as to control the drive circuit 252 to change the level state of the first control signal, trigger the rectifier circuit 24 to change the switch state based on the first control signal and regulate the second DC signal; the isolation transformer 23 regulates the current of the resonant circuit 22.

Further, in an embodiment, the control circuit 25 also includes a first proportional filtering correction circuit 2531 and a second proportional filtering correction circuit 2532; the sampling circuit 251 includes a first sampling circuit (not marked in the drawing) and a second sampling circuit (not marked in the drawing); the first sampling circuit is coupled with the isolation transformer 23 and the first proportional filtering correction circuit 2531, and the second sampling circuit is coupled with the rectifier circuit 24 and the second proportional filtering correction circuit 2532.

Wherein, the first sampling circuit obtains the first AC signal and/or the second AC signal from the isolation transformer 23 by sampling; the second sampling circuit obtains the second DC signal from the rectifier circuit 24 by sampling.

The first proportional filtering correction circuit 2531 receives the first AC signal and/or the second AC signal, and sends the first AC signal and/or the second AC signal to the signal processing circuit after comparison with reference value, filtration and correction; the signal processing circuit controls the drive circuit 252 to generate a third drive signal PWM1 and a fourth drive signal PWM2; above signal processing steps provide high quality input to the control circuit 25 so as to optimize the overall performance and reliability and effectively realize efficient control.

Furthermore, the second proportional filtering correction circuit 2532 receives the second DC signal from the second sampling circuit, and sends the second DC signal to the signal processing circuit after comparison with reference value, filtration and correction; the signal processing circuit controls the drive circuit 252 to generate a first drive signal PWMA and a second drive signal PWMB; above signal processing steps provide high quality input to the control circuit 25 so as to optimize the overall performance and reliability and effectively realize efficient control.

In an embodiment, the rectifier circuit 24 includes a third switch sub-circuit 241 and a fourth switch sub-circuit 242 and the isolation transformer 23 further includes a primary winding 231 and a secondary winding 232; the primary winding 231 is coupled with the resonant circuit 22, the first switch sub-circuit 211, the second switch sub-circuit 212 and the secondary winding 232, the secondary winding 232 is coupled with the third switch sub-circuit 241, the fourth switch sub-circuit 242 and the sampling circuit, the third switch sub-circuit 241 is coupled with the fourth switch sub-circuit 242 and the control circuit 25, and is for coupling with the load circuit 102, and the fourth switch sub-circuit 242 is coupled with the control circuit 25.

Wherein, the first control signal further includes a third drive signal PWM1 and a fourth drive signal PWM2; the third drive signal PWM1 and the fourth drive signal PWM2 have opposite phases, i.e., the two have opposite level states; when the third drive signal PWM1 is in the first level state, the fourth drive signal PWM2 is in the second level state; when the third drive signal PWM1 is in the second level state, the fourth drive signal PWM2 is in the first level state.

The first AC signal includes the first voltage signals on both ends of the primary winding 231 and the second AC signal includes the second voltage signals on both ends of the secondary winding 232.

Further, the primary winding 231 receives the regulated first AC signal from the resonant circuit 22, and converts the first AC signal to the second AC signal by electromagnetic coupling with the secondary winding 232; the electromagnetic connection replaces electrical connection to realize electrical isolation and voltage matching between the primary side and the secondary side to meet the requirements for the primary side and the secondary side in safety regulations.

The secondary winding 232 further sends the second AC signal to the third switch sub-circuit 241 and the fourth switch sub-circuit 242; by responding to the level change of the first control signal, the third switch sub-circuit 241 and the fourth switch sub-circuit 242 control the switching time of the internal switch state, and convert the second AC signal to the second DC signal.

In some embodiments, the third switch sub-circuit 241 receives the third drive signal PWM1 and controls the switching time of internal switch state by responding to the level change of the third drive signal PWM1. In some embodiments, the third drive signal PWM1 changes the level state in rise and drop of the first voltage signal and/or rise and drop of the second voltage signal to trigger the third switch sub-circuit 241 to change the switch state.

The fourth switch sub-circuit 242 receives the fourth drive signal PWM2 and controls the switching time of internal switch state by responding to the level change of the fourth drive signal PWM2. In some embodiments, the fourth drive signal PWM2 changes the level state in rise and drop of the first voltage signal and/or rise and drop of the second voltage signal to trigger the fourth switch sub-circuit 242 to change the switch state to match with the switch state of the third switch sub-circuit 241, and regulate the second DC signal; the isolation transformer 23 regulates the current of the resonant circuit 22. For example, before the change of the switch states of the first switch sub-circuit 211 and the second switch sub-circuit 212, the phase of the current of the resonant circuit 12 remains unchanged to ensure the inverter circuit ZVS ON and OFF to minimize switch losses, improve efficiency and reduce electromagnetic interference.

Further, in an embodiment, the control circuit 25 regulates the first level state of the third drive signal PWM1 to the second level state when the first voltage signal or the second voltage signal rises, i.e., there is a rise edge of waveform diagram of the first voltage signal or the second voltage signal, the voltage change rate of the first voltage signal is higher than a first set rate or the voltage change rate of the second voltage signal is higher than the first set rate; the control circuit 25 regulates the second level state of the third drive signal PWM1 to the first level state when the first voltage signal or the second voltage signal drops.

Similarly, the control circuit 25 regulates the first level state of the fourth drive signal PWM2 to the second level state by responding to drop of the first voltage signal or the second voltage signal; the control circuit 25 regulates the second level state of the fourth drive signal PWM2 to the first level state when the first voltage signal and/or the second voltage signal rise/rises, i.e., there is a rise edge of waveform diagram of the first voltage signal or the second voltage signal, the voltage change rate of the first voltage signal is higher than a second set rate or the voltage change rate of the second voltage signal is higher than the second set rate.

In other embodiments, the second AC signal also includes a first current signal Iup of the third switch sub-circuit 241 and a second current signal Idn of the fourth switch sub-circuit 242; when the first current signal Idn attenuates to 0 forward, the control circuit 25 regulates the second level state of the third drive signal PWM1 to the first level state; when the second current signal Idn attenuates to 0 forward, the control circuit 25 regulates the second level state of the fourth drive signal PWM2 to the first level state.

It is worth noting that as shown in FIG. 2, in some embodiments, the first current signal Iup may be corresponding to current between the node N1 and the node N2 and the second current signal Idn may be corresponding to current between the node N3 and the node N2.

In another embodiment, the secondary winding 232 also includes a first sub secondary winding 2321 and a second sub secondary winding 2322; in some embodiments, the control circuit 25 further includes a sampling circuit 251, a signal processing circuit (not marked in the drawing) and a drive circuit 252; the sampling circuit 251 also includes a third sampling circuit 2511 and a fourth sampling circuit 2512; the first sub secondary winding 2321 is coupled with the third switch sub-circuit 241, the second sub secondary winding 2322 is coupled with the fourth switch sub-circuit 242, both the first sub secondary winding 2321 and the second sub secondary winding 2322 are coupled with the primary winding 231; the third sampling circuit 2511 is coupled with the third switch sub-circuit 241 and the signal processing circuit, the fourth sampling circuit 2512 is coupled with the fourth switch sub-circuit 242 and the signal processing circuit, the signal processing circuit is coupled with the drive circuit 252, and the drive circuit 252 is coupled with the first switch sub-circuit 211, the second switch sub-circuit 212, the third switch sub-circuit 241 and the fourth switch sub-circuit 242.

Wherein, the second voltage signal further includes a first secondary side voltage signal Vup and a second secondary side voltage signal Vdn.

It is worth noting that as shown in FIG. 2, in some embodiments, the first secondary side voltage signal Vup may be corresponding to the voltage between the node N1 and the node N4, while the second secondary side voltage signal Vdn may be corresponding to the voltage between the node N3 and the node N4.

Wherein, the third sampling circuit 2511 obtains the first secondary side voltage signal Vup by sampling and the fourth sampling circuit 2512 obtains the second secondary side voltage signal Vdn by sampling; in some embodiments, the signal processing circuit also controls the drive circuit 252 to regulate the first level state of the third drive signal PWM1 to the second level state when the obtained first secondary side voltage signal Vup rises, i.e., there is a rise edge in the waveform of the first secondary side voltage signal Vup, or the voltage change rate of the first secondary side voltage signal Vup is higher than the first set rate, and controls the drive circuit 252 to regulate the second level state of the third drive signal PWM1 to the first level state when the obtained first current signal Iup attenuates to 0 forward.

Similarly, the signal processing circuit also controls the drive circuit 252 to regulate the first level state of the fourth drive signal PWM2 to the second level state when the second secondary side voltage signal Vdn rises, i.e., there is a rise edge in the waveform of the second secondary side voltage signal Vdn, or the voltage change rate of the second secondary side voltage signal Vdn is higher than the second set rate, and controls the drive circuit 252 to regulate the second level state of the fourth drive signal PWM2 to the first level state when the obtained second current signal Idn attenuates to 0 forward.

Wherein, when the level state changes, the third drive signal PWM1 triggers the third switch sub-circuit 241 to change the switch state; when the level state changes, the fourth drive signal PWM2 triggers the fourth switch sub-circuit 242 to change the switch state to match with the switch state of the third switch sub-circuit 241 and to regulate the second DC signal; the isolation transformer 23 regulates the current of the resonant circuit 22. For example, before the change of the switch states of the first switch sub-circuit 211 and the second switch sub-circuit 212, the phase of the current of the resonant circuit 12 remains unchanged to ensure the inverter circuit ZVS ON and OFF to minimize switch losses, improve efficiency and reduce electromagnetic interference.

In an embodiment, when the signal frequency of the second control signal is lower than the resonant frequency of the resonant circuit, and when the first drive signal PWMA is in the second level state, the second drive signal PWMB is in the first level state, the third drive signal PWM1 is in the first level state and the fourth drive signal PWM2 is in the second level state, and/or when the first drive signal PWMA is in the first level state, the second drive signal PWMB is in the second level state, the third drive signal PWM1 is in the second level state and the fourth drive signal PWM2 is in the first level state, the phase of the third current IL of the resonant circuit 22 maintains unchanged, i.e., before the change of the switch state of the first switch sub-circuit 211 and the second switch sub-circuit 212 of the third current IL, the phase of the third current IL of the resonant circuit 12 remains unchanged to ensure the inverter circuit 21 ZVS ON and OFF.

Thus, the power circuit 20 can realize soft switching not only when working at the frequency higher than or equal to the resonant frequency working range of the resonant circuit 22, but also when working at the frequency lower than the resonant frequency working range. In addition, the power circuit 20 can effectively guarantee its high efficiency and high reliability in full frequency working range and expand its maximum gain range for wide application.

In an embodiment, the first switch sub-circuit 211 also includes a first switching tube T1 and a fourth switching tube T4, and the second switch sub-circuit 212 includes a second switching tube T2 and a third switching tube T3; wherein, the first end of the first switching tube T1 is coupled with the first end of the third switching tube T3 and is for coupling with the first end of the DC power source 101, the second end of the first switching tube T1 is coupled with the first end of the second switching tube T2 and the first end of the resonant circuit 22, the second end of the third switching tube T3 is coupled with the first end of the fourth switching tube T4 and the second end of the isolation transformer 23, and the second end of the second switching tube T2 is coupled with the second end of the fourth switching tube T4 and is for coupling with the second end of the DC power source 101.

It may be understood that the third ends of the first switching tube T1, the second switching tube T2, the third switching tube T3 and the fourth switching tube T4 are coupled with the control output end of the control circuit 25 to form corresponding full-bridge inverter circuit 21 which receives the first drive signal PWMA and the second drive signal PWMB from the control circuit 25, triggers ON or OFF under the action of the first drive signal PWMA and the second drive signal PWMB and converts the first DC signal to the first AC signal.

In some embodiments, the control circuit 25 may adopt a PWM control strategy to realize ON and OFF control of the full-bridge inverter circuit 21 formed by the first switching tube T1, the second switching tube T2, the third switching tube T3 and the fourth switching tube T4 to convert the first DC signal to the first AC signal to meet the power supply demand of the load circuit 102 in different working conditions.

In some embodiments, the first switching tube T1, the second switching tube T2, the third switching tube T3, the fourth switching tube T4 and switching tubes mentioned below may be a MOS tube, a high-frequency transistor, a triode, a SCR, a IGBT and one or a plurality of any reasonable switching devices. However, the present disclosure is not limited to the embodiments described herein.

The third ends of all switching tubes in this application are the control ends to trigger the first end and the second end ON in the second level state of the drive signal and trigger the first end and the second end OFF in the first level state of the drive signal when the third ends of all switching tubes receive the corresponding drive signals.

Further, in an embodiment, the secondary winding 232 also includes a first sub secondary winding 2321 and a second sub secondary winding 2322, the third switch sub-circuit 241 includes a fifth switching tube T5, and the fourth switch sub-circuit 242 includes a sixth switching tube T6; wherein, the first end of the first sub secondary winding 2321 is coupled with the first end of the fifth switching tube T5, the second end of the first sub secondary winding 2321 is coupled with the second end of the second sub secondary winding 2322 and is for coupling with the second end of the load circuit 102, the first end of the second sub secondary winding 2322 is coupled with the first end of the sixth switching tube T6, and the second end of the fifth switching tube T5 is coupled with the second end of the sixth switching tube T6 and is for coupling with the first end of the load circuit 102.

It may be understood that the third end of the fifth switching tube T5 and the third end of the sixth switching tube T6 are coupled with the control output end of the control circuit 25 to form corresponding half-bridge rectifier circuits to receive the third drive signal PWM1 and the fourth drive signal PWM2 from the control circuit 25, to trigger ON and OFF under the action of the third drive signal PWM1 and the fourth drive signal PWM2 and to convert the second AC signal to the second DC signal.

In an embodiment, the resonant circuit 22 further includes a resonant capacitor Cr and a resonant inductor Lr; the first end of the resonant capacitor Cr is coupled with the second end of the first switching tube T1 and the first end of the second switching tube T2, the second end of the resonant capacitor Cr is coupled with the first end of the resonant inductor Lr and the second end of the resonant inductor Lr is coupled with the first end of the primary winding 231.

It is worth noting that the resonant capacitor Cr and the resonant inductor Lr form series resonance and have the specific resonant frequency.

Further, in an embodiment, the control circuit 25 may directly send the second control signal simultaneously with the first control signal and make the second control signal and the first control signal the same when the signal frequency of the second control signal is higher than or equal to the resonant frequency of the resonant circuit 22.

When the signal frequency of the second control signal is lower than or equal to the resonant frequency of the resonant circuit 22, the control circuit 25 obtains the first AC signal and/or the second AC signal in the isolation transformer 23 by sampling, changes the level state of the second control signal when the first AC signal voltage rises and/or drops, and/or the second AC signal voltage rises and/or drops, and triggers the rectifier circuit 24 to change the switch state and regulate the second DC signal; the isolation transformer 23 regulates the current of the resonant circuit 22 to ensure the inverter circuit 21 ZVS ON and OFF to minimize switch losses, improve efficiency and reduce electromagnetic interference.

In an embodiment, the power circuit 20 also includes a filter output circuit 26 which further includes an output resistor Ro and an output capacitor Co; in some embodiments, the load circuit 102 may be equivalent to a load resistor R; the first end of the output resistor Ro is coupled with the second end of the fifth switching tube T5, the second of the sixth switching tube T6 and the first end of the load resistor R, the second end of the output resistor Ro is coupled with the first end of the output capacitor Co, and the second end of the output capacitor Co is coupled with the second end of the first sub secondary winding 2321, the second end of the second sub secondary winding 2322 and the second end of the load resistor R. The output resistor Ro is for coordinating with the output capacitor Co to stably output the second DC signal to the load resistor R.

In other embodiments, the load circuit 102 may be equivalent to a load capacitor (not marked in the drawing) or a load inductor (not marked in the drawing), or any two or any three among the output resistor Ro, the load capacitor and the load inductor, or any other reasonable circuit structures with different circuit components and connection methods. However, the present disclosure is not limited to the embodiments described herein.

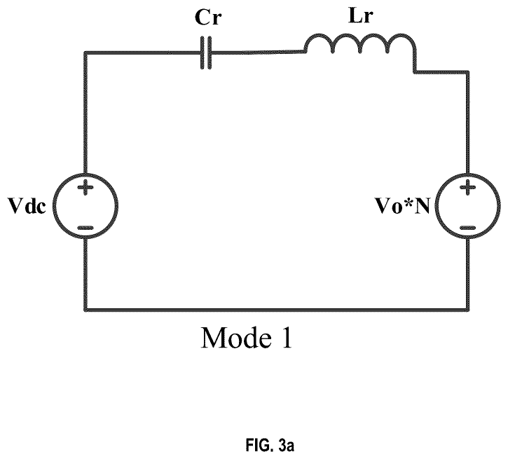

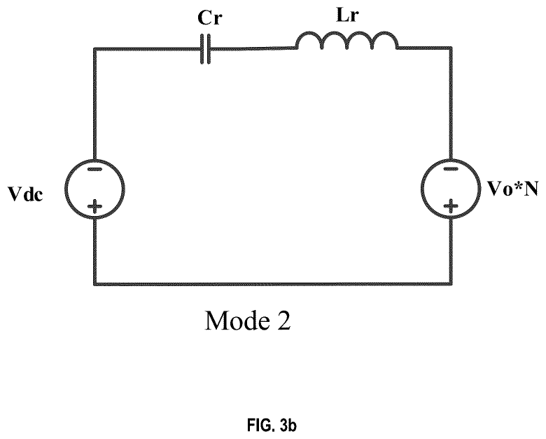

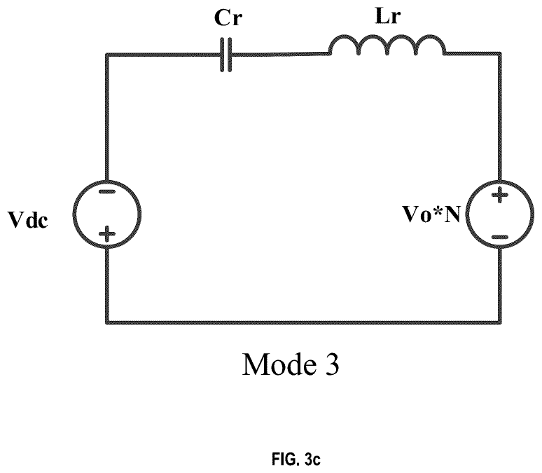

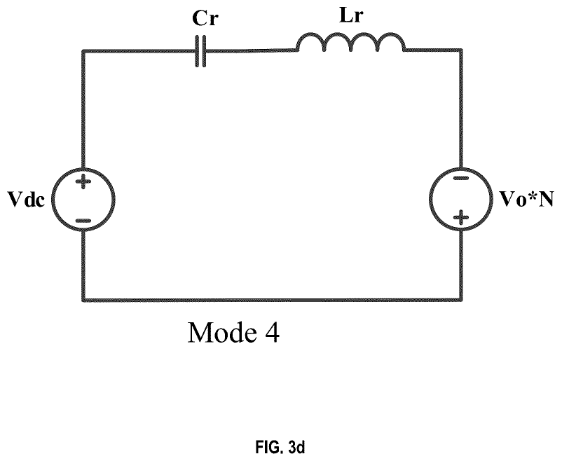

To explain the specific control strategy of the control circuit 25, referring to FIGS. 3a-3d, wherein, FIG. 3a. illustrates an equivalent circuit diagram of the resonant circuit in mode 1 in FIG. 2, FIG. 3b. illustrates an equivalent circuit diagram of the resonant circuit in mode 2 in FIG. 2, FIG. 3c. illustrates an equivalent circuit diagram of the resonant circuit in mode 3 in FIG. 2 and FIG. 3d. illustrates an equivalent circuit diagram of the resonant circuit in mode 4 in FIG. 2.

It may be understood that the first drive signal PWMA, the second drive signal PWMB, the third drive signal PWM1 and the fourth drive signal PWM2 have the first level state and the second level state; when any one or a plurality of drive signals is/are in the second level state, a switching tube which receives the drive signal is triggered ON; when any one or a plurality of drive signals is/are in the first level state, a switching tube which receives the drive signal is triggered OFF. The switching tube states (ON/OFF) of the primary side and the secondary side of the isolation transformer 23 are corresponding to four different working modes of the resonant circuit 22.

Furthermore, the voltage of the first DC signal from the DC power source is Vdc; the voltage of the second DC signal of the load circuit from the power circuit is Vo and the corresponding current is Io; the current of the resonant circuit 22 is IL.

Mode 1: the first drive signal PWMA is in the second level state, the second drive signal PWMB is in the first level state, the first switching tube T1 is ON, the second switching tube T2 is OFF, the third switching tube T3 is OFF and the fourth switching tube T4 is ON; the third drive signal PWM1 is in the second level state, the fourth drive signal PWM2 is in the first level state, the fifth switching tube T5 is ON and the sixth switching tube T6 is OFF. As shown in FIG. 3a, the input voltage of the resonant circuit 22 is Vdc and the output voltage of the resonant circuit 22 is Vo*N (N is positive and is a transformation ratio coefficient of the isolation transformer 23) which is obtained by converting the output voltage Vo of the second DC signal from the secondary side to the primary side by the isolation transformer 23.

Mode 2: the first drive signal PWMA is in the first level state, the second drive signal PWMB is in the second level state, the first switching tube T1 is OFF, the second switching tube T2 is ON, the third switching tube T3 is ON and the fourth switching tube T4 is OFF; the third drive signal PWM1 is in the first level state, the fourth drive signal PWM2 is in the second level state, the fifth switching tube T5 is OFF and the sixth switching tube T6 is ON. As shown in FIG. 3b, the input voltage of the resonant circuit 22 is −Vdc and the output voltage of the resonant circuit 22 is −Vo*N.

Mode 3: the first drive signal PWMA is in the first level state, the second drive signal PWMB is in the second level state, the first switching tube T1 is OFF, the second switching tube T2 is ON, the third switching tube T3 is ON and the fourth switching tube T4 is OFF; the third drive signal PWM1 is in the second level state, the fourth drive signal PWM2 is in the first level state, the fifth switching tube T5 is ON and the sixth switching tube T6 is OFF. As shown in FIG. 3c, the input voltage of the resonant circuit 22 is −Vdc and the output voltage of the resonant circuit 22 is Vo*N.

Mode 4: the first drive signal PWMA is in the second level state, the second drive signal PWMB is in the first level state, the first switching tube T1 is ON, the second switching tube T2 is OFF, the third switching tube T3 is OFF, and the fourth switching tube T4 is ON; the third drive signal PWM1 is in the first level state, the fourth drive signal PWM2 is in the second level state, the fifth switching tube T5 is OFF and the sixth switching tube T6 is ON. As shown in FIG. 3d, the input voltage of the resonant circuit 22 is Vdc and the output voltage of the resonant circuit 22 is −Vo*N.

Wherein, in some embodiments, the control circuit 25 obtains the output voltage Vo and the output current Jo of the second DC signal outputted to the load circuit 102 by sampling; after the feedback loop compensation operation, the control circuit 25 determines the signal frequency f of the first drive signal PWMA and the second drive signal PWMB. Supposing the resonant frequency of the resonant circuit 22 is fs, the power circuit 20 works in three typical working states in different input and output scenarios.

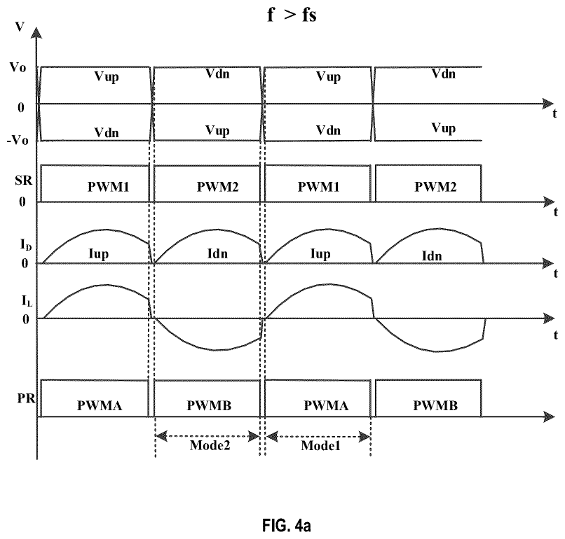

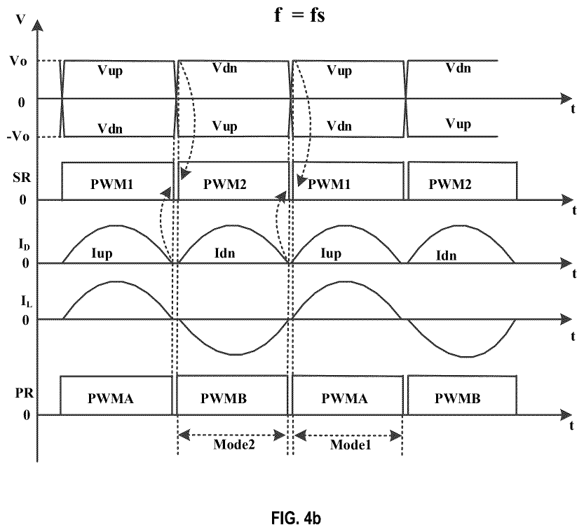

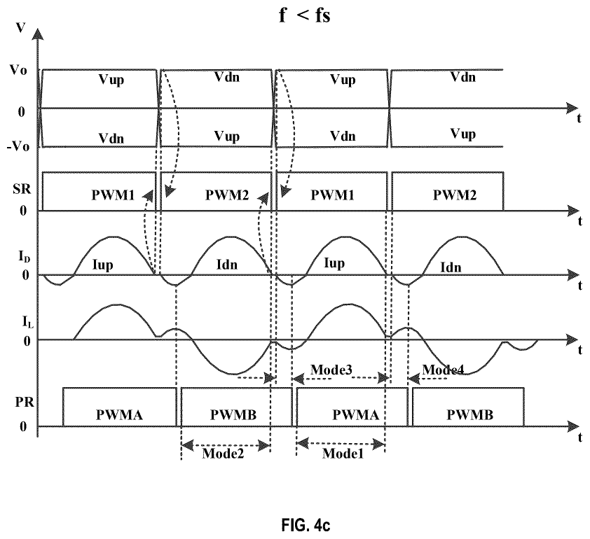

Referring to FIGS. 4a-4c, wherein, FIG. 4a. illustrates a waveform diagram of sampling signals and control signals when the signal frequency of the second control signal from the control circuit is higher than the resonant frequency of the resonant circuit in FIG. 2, FIG. 4b. illustrates a waveform diagram of sampling signals and control signals when the signal frequency of the second control signal from the control circuit is equal to the resonant frequency of the resonant circuit in FIG. 2, and FIG. 4c. illustrates a waveform diagram of sampling signals and control signals when the signal frequency of the second control signal from the control circuit is lower than the resonant frequency of the resonant circuit in FIG. 2.

Working State I (f>Fs):

As shown in FIG. 4a, the signal frequency f of the first drive signal PWMA and the second drive signal PWMB is higher than the resonant frequency fs of the resonant circuit 22. Wherein, when the second drive signal PWMB is in the first level state and the first drive signal PWMA is in the second level state, the input voltage of the resonant circuit 22 is Vdc; besides, when the third voltage Vup rises and the fourth voltage Vdn drops, or when the third drive signal PWM1 and the first drive signal PWMA are directly sent synchronously, the third drive signal PWM1 is same with the first drive signal PWMA, and when the fourth drive signal PWM2 and the second drive signal PWMB are sent synchronously, the fourth drive signal PWM2 is same with the second drive signal PWMB, the first level state of the third drive signal PWM1 is regulated to the second level state, the second level state of the fourth drive signal PWM2 is regulated to the first level state and the output voltage of the resonant circuit 22 is Vo*N which is obtained by converting the output voltage Vo of the second DC signal from the secondary side to the primary side by the isolation transformer 23. At this time, the resonant circuit 22 is working in mode 1.

When the first drive signal PWMA is in the first level state and the second drive signal PWMB is in the second level state, the input voltage of the resonant circuit 22 is −Vdc; besides, when the fourth voltage Vdn rises and the third voltage Vup drops, or when the third drive signal PWM1 and the first drive signal PWMA are directly sent synchronously, the third drive signal PWM1 is same with the first drive signal PWMA, and when the fourth drive signal PWM2 and the second drive signal PWMB are sent synchronously, the fourth drive signal PWM2 is same with the second drive signal PWMB, the third drive signal PWM1 is in the second level state, the second level state of the fourth drive signal PWM2 is regulated to the first level state, and the output voltage of the resonant circuit 22 is −Vo*N. At this time, the resonant circuit 22 is working in mode 2.

The signal waveform of FIG. 4a shows that the resonant circuit 22 works in mode 1 and mode 2 alternately, the first switching tube T1, the second switching tube T2, the third switching tube T3 and the fourth switching tube T4 on the primary side of the isolation transformer 23 may realize ZVS ON; the fifth switching tube T5 and the sixth switching tube T6 on the secondary side of the isolation transformer 23 may realize ZVS ON and small current OFF.

Working State II (f=Fs):

As shown in FIG. 4b, the signal frequency f of the first drive signal PWMA and the second drive signal PWMB is equal to the resonant frequency fs of the resonant circuit 22. When the second drive signal PWMB is in the first level state and the first drive signal PWMA is in the second level state, the input voltage of the resonant circuit 22 is Vdc; besides, when the fourth voltage Vdn rises and the third voltage Vup drops, or when the third drive signal PWM1 and the first drive signal PWMA are directly sent synchronously, the third drive signal PWM1 is same with the first drive signal PWMA, and when the fourth drive signal PWM2 and the second drive signal PWMB are sent synchronously, the fourth drive signal PWM2 is same with the second drive signal PWMB, the first level state of the third drive signal PWM1 is regulated to the second level state, the second level state of the fourth drive signal PWM2 is regulated to the first level state, and the output voltage of the resonant circuit 22 is Vo*N. At this time, the resonant circuit 22 is working in mode 1.

When the first drive signal PWMA is in the first level state and the second drive signal PWMB is in the second level state, the input voltage of the resonant circuit 22 is −Vdc; besides, when the third voltage Vup rises and the fourth voltage Vdn drops, or when the third drive signal PWM1 and the first drive signal PWMA are directly sent synchronously, the third drive signal PWM1 is same with the first drive signal PWMA, and when the fourth drive signal PWM2 and the second drive signal PWMB are sent synchronously, the fourth drive signal PWM2 is same with the second drive signal PWMB, the first level state of the third drive signal PWM1 is regulated to the second level state, the second level state of the fourth drive signal PWM2 is regulated to the first level state, and the output voltage of the resonant circuit 22 is −Vo*N. At this time, the resonant circuit 22 is working in mode 2.

The signal waveform of FIG. 4b shows that the resonant circuit 22 works in mode 1 and mode 2 alternately, and the first switching tube T1, the second switching tube T2, the third switching tube T3 and the fourth switching tube T4 on the primary side of the isolation transformer 23 may realize ZVS ON; the fifth switching tube T5 and the sixth switching tube T6 on the secondary side of the isolation transformer 23 may realize ZVS ON and OFF.

Working State III (f<Fs):

As shown in FIG. 4c, the signal frequency f of the first drive signal PWMA and the second drive signal PWMB is lower than the resonant frequency fs of the resonant circuit 22. When the first drive signal PWMA is in the second level state, the input voltage of the resonant circuit 22 is Vdc; besides, when the third voltage Vup rises and the fourth voltage Vdn drops, the first level state of the third drive signal PWM1 is regulated to the second level state, the current of the fifth switching tube T5 attenuates towards 0 forward, the third drive signal PWM1 maintains ON, and the output voltage of the resonant circuit 22 is Vo*N. At this time, the resonant circuit 22 is working in mode 1.

After about half resonant period of the resonant circuit 22, the first drive signal PWMA maintains until the state is ON, and the input voltage of the resonant circuit 22 is Vdc; affected by the excitation current from the resonant circuit 22 to the isolation transformer 23, the current of the fifth switching tube T5 attenuates to 0 forward, and the second level state of the third drive signal PWM1 is regulated to the first level state; besides, when the fourth voltage Vdn rises and the third voltage Vup drops, the first level state of the fourth drive signal PWM2 is regulated to the second level state and the output voltage of the resonant circuit 22 is −Vo*N. At this time, the resonant circuit 22 is working in mode 4.

When the first drive signal PWMA is in the first level state and the second drive signal PWMB is in the second level state, the input voltage of the resonant circuit 22 is −Vdc; besides, when the fourth voltage Vdn rises and the third voltage Vup drops, after the first level state of the fourth drive signal PWM2 is regulated to the second level state, the current of the sixth switching tube T6 attenuates to 0 forward, the fourth drive signal PWM2 is maintained in the second level state and the output voltage of the resonant circuit 22 is −Vo*N. At this time, the resonant circuit 22 is working in mode 2.

After about half resonant period of the resonant circuit 22, the second drive signal PWMB maintains in the second level state, the input voltage of the resonant circuit 22 is −Vdc; affected by the excitation current from the resonant circuit 22 to the isolation transformer 23, the current of the sixth switching tube T6 attenuates to 0 forward, and the second level state of the fourth drive signal PWM2 is regulated to the first level state; besides, when the third voltage Vup rises and the fourth voltage Vdn drops, the first level state of the third drive signal PWM1 is regulated to the second level state and the output voltage of the resonant circuit 22 is Vo*N. At this time, the resonant circuit 22 is working in mode 3.

The signal waveform of FIG. 4c shows that the resonant circuit 22 works in mode 1, mode 4, mode 2 and mode 3 alternately; in mode 3 and mode 4, the excitation current can be well maintained to the switching of the first drive signal PWMA and the second drive signal PWMB, i.e., before change of the switch state of the first switching tube T1, the second switching tube T2, the third switching tube T3 and the fourth switching tube T4, the phase of the third current IL of the resonant circuit 12 remains unchanged to ensure the inverter circuit ZVS ON and OFF and ensure the first switching tube T1, the second switching tube T2, the third switching tube T3 and the fourth switching tube T4 on the primary side of the isolation transformer 23 to realize ZVS ON and the fifth switching tube T5 and the sixth switching tube T6 on the secondary side of the isolation transformer 23 to realize ZCS ON.

In light of this, based on the analysis of above typical working states, if the power circuit 20 and the corresponding control method in the embodiment are adopted, the signal frequency of the control signal of the power circuit 20 can realize soft switching not only within or higher than the resonant frequency working range of the resonant circuit 22, but also lower than the resonant frequency working range of the resonant circuit 22; the power circuit 20 in this embodiment and relevant control method can better realize high efficiency, high reliability and low noises.

Furthermore, because in mode 3 and mode 4, the voltage of both ends of the resonant circuit 22 is higher than the voltage of the first DC signal Vdc from the DC power source 101, and in some embodiments, is the twice of the first DC signal voltage Vdc, or is within any set reasonable voltage range, which is higher than the first DC signal voltage Vdc, with the twice first DC signal voltage Vdc as median value. The resonant circuit 22 can store more power in the current control stage to deal with power outage and extend the power holding time of the resonant circuit 22 in power outage.

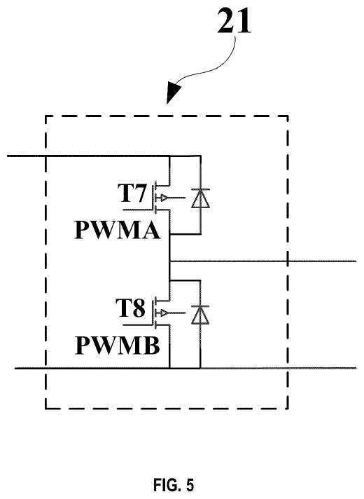

Referring to FIG. 5, FIG. 5. illustrates a structural schematic diagram of another embodiment of the inverter circuit of the power circuit in FIG. 2.

In another embodiment, the first switch sub-circuit 211 may also include a seventh switching tube T7 and the second switch sub-circuit 212 includes an eighth switching tube T8; wherein, the first end of the seventh switching tube T7 is for coupling with the first end of the DC power source 101, the second end of the seventh switching tube T7 is coupled with the first end of the eighth switching tube T8 and the first end of the resonant circuit 22, the second end of the eighth switching tube T8 is coupled with the second end of the isolation transformer 23 and is for coupling with the second end of the DC power source 101, and the third end of the seventh switching tube T7 and the third end of the eighth switching tube T8 are coupled with the control output end of the control circuit 25.

It may be understood that in some embodiments, the seventh switching tube T7 and the eighth switching tube T8 may also form a half-bridge inverter circuit 21 to receive the first drive signal PWMA and the second drive signal PWMB from the control circuit 25, trigger ON or OFF under the action of the first drive signal PWMA and the second drive signal PWMB, and convert the first DC signal to the first AC signal.

In other embodiments, the inverter circuit 21 may also be a symmetric half-bridge or asymmetric half-bridge circuit and any other reasonable circuits for realizing inversion. However, the present disclosure is not limited to the embodiments described herein.

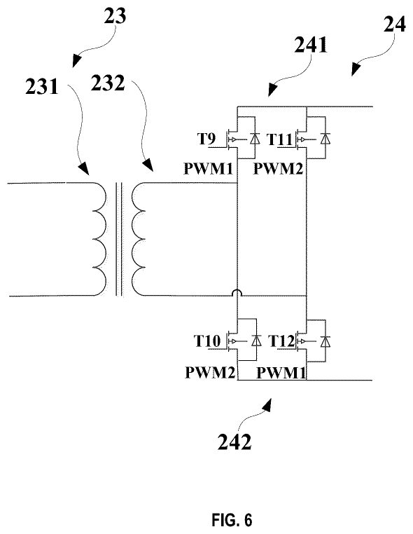

Referring to FIG. 6, FIG. 6. illustrates a structural schematic diagram of another embodiment of the rectifier circuit of the power circuit in FIG. 2.

In another embodiment, the third switch sub-circuit 241 may also include a ninth switching tube T9 and a twelfth switching tube T12, and the fourth switch sub-circuit 242 includes a tenth switching tube T10 and an eleventh switching tube Ti1; wherein, the first end of the secondary winding 232 is coupled with the first end of the ninth switching tube T9 and the second end of the tenth switching tube T10, the second end of the secondary winding 232 is coupled with the first end of the eleventh switching tube T11 and the second end of the twelfth switching tube T12, the second end of the ninth switching tube T9 is coupled with the second end of the eleventh switching tube T11 and is for coupling with the first end of the load circuit 102, the first end of the tenth switching tube T10 is coupled with the first end of the twelfth switching tube T12 and is for coupling with the second end of the load circuit 102, and the third ends of the ninth switching tube T9, the tenth switching tube T10, the eleventh switching tube T11 and the twelfth switching tube T12 are coupled with the control output end of the control circuit 25.

It may be understood that in some embodiments, the ninth switching tube T9, the twelfth switching tube T12, the tenth switching tube T10 and the eleventh switching tube T11 form a full-bridge rectifier circuit to receive the third drive signal PWM1 and the fourth drive signal PWM2 from the control circuit 25, trigger ON or OFF under the action of the third drive signal PWM1 and the fourth drive signal PWM2, and convert the second AC signal to the second DC signal.

In other embodiments, the rectifier circuit 24 may also be a forward full-wave rectifier or reverse full-wave rectifier circuit or any other reasonable circuits for realizing rectification. However, the present disclosure is not limited to the embodiments described herein.

Specifically, the embodiments of the application provide a power control method. Referring to FIG. 7, FIG. 7. illustrates a process schematic diagram of an embodiment of the power control method in this application. In some embodiments, the power control method may include the following steps:

S31: receiving the first DC signal from the DC power source.

It may be understood that in some embodiments, the power control method in this embodiment refers to a control method that the power circuit converts the DC power from the DC power source to the AC power and then converts the AC power to the DC power. Wherein, in some embodiments, the power circuit includes an inverter circuit, a resonant circuit, an isolation transformer, a rectifier circuit and a control circuit; the inverter circuit is for coupling with the DC power source, the resonant circuit is coupled with the inverter circuit, the isolation transformer is coupled with the resonant circuit, the rectifier circuit is coupled with the isolation transformer and is for coupling with the load circuit, and the control circuit is coupled with the inverter circuit and the rectifier circuit.

In some embodiments, the inverter circuit receives the first DC signal with constant current and/or voltage from the DC power source.

S32: converting the first DC signal to the first AC signal.

Further, the inverter circuit rapidly switches the DC power to generate an alternating voltage waveform and obtain the first AC signal under the signal control with the internal switch action mechanism, such as IGBTs, high-frequency transistors, MOSs and other switch devices.

S33: regulating the first AC signal.

The resonant circuit receives the first AC signal from the inverter circuit and carries out one or a plurality of any reasonable signal regulations for the first AC signal, such as filtration shaping and phase shifting with a view to achieving better output characteristics to ensure the followed component, such as the rectifier circuit or the load, obtains more stable and more efficient power.

S34: converting the regulated first AC signal to the second AC signal.

The isolation transformer receives the regulated first AC signal from the resonant circuit and converts the regulated first AC signal to the second AC signal; the electromagnetic connection replaces electrical connection to realize electrical isolation and voltage matching between the primary side and the secondary side to meet the requirements for the primary side and the secondary side in safety regulations.

S35: converting the second AC signal to the second DC signal and outputting the second DC signal to the load circuit.

The rectifier circuit receives the second AC signal from the isolation transformer, obtains stable DC output, i.e., the second DC signal, based on the second AC signal by high-frequency rectification technologies, such as PWM, synchronous rectification, inverse damping rectification and any other reasonable rectification modes, and outputs the second DC signal to the load circuit for supplying power.

S36: generating the first control signal based on rise and/or drop of the regulated first AC signal voltage and/or rise and/or drop of the second AC signal voltage.

The control circuit obtains the first AC signal and/or the second AC signal from the voltage by sampling, and generates the first control signal based on rise and/or drop of the regulated first AC signal voltage and/or rise and/or drop of the second AC signal voltage.

S37: regulating the second DC signal based on the first control signal.

The rectifier circuit receives the first control signal from the control circuit, changes the switch state under the action of the first control signal, and regulates the second DC signal; the isolation transformer regulates the current of the resonant circuit; for example, before the change of the switch state of the inverter circuit, the phase of the current of the resonant circuit remains unchanged to ensure the inverter circuit ZVS ON and OFF.

Further, in an embodiment, after S35, the step also includes: comparing the second DC signal with the preset power threshold to determine the signal frequency of the second control signal; regulating the first AC signal based on the second control signal.

In some embodiments, the control circuit obtains the second DC signal of the load circuit from the rectifier circuit by sampling, compares the obtained second DC signal with the preset power threshold to determine the signal frequency of the second control signal based on the comparison difference between the second DC signal and the preset power threshold, and sends the second control signal to the inverter circuit at the determined signal frequency to trigger the inverter circuit to regulate the switch state, to regulate the first AC signal from the inverter circuit and to regulate the second DC signal.

It is worth noting that the second DC signal includes the current signal and the voltage signal. In some embodiments, the preset power threshold may be understood as the target power supply demand of the load circuit, such as the target set value of required voltage, current or power output of the power source of the load circuit, and may also be understood as the preset target power supply signal. In some embodiments, the control circuit dynamically regulates the signal frequency of the second control signal based on the difference between the second DC signal and the preset power threshold; for example, when the second DC signal is lower than the preset power threshold, increase the signal frequency of the second control signal, and when the second DC signal is higher than the preset power threshold, reduce the signal frequency of the second control signal until reaching the target set value of voltage, current or power, i.e., within the preset power threshold range, and determine the signal frequency of the second control signal in a stable state.

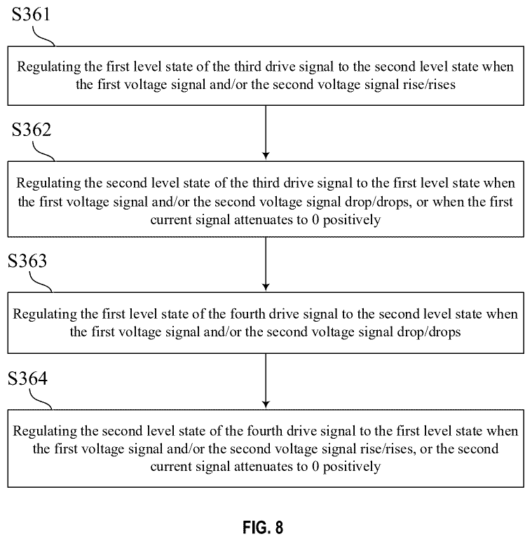

Referring to FIG. 8, FIG. 8. illustrates a process diagram of an embodiment of S36 in FIG. 7. In an embodiment, besides S31-S37, the power control method further includes some more specific steps. In some embodiments, S36 may also include the following steps:

S361: regulating the first level state of the third drive signal to the second level state when the first voltage signal and/or the second voltage signal rise/rises.

It may be understood that in some embodiments, the inverter circuit also includes a first switch sub-circuit and a second switch sub-circuit, the rectifier circuit includes a third switch sub-circuit and a fourth switch sub-circuit, and the isolation transformer includes a primary winding and a secondary winding; the first switch sub-circuit is coupled with the second switch sub-circuit, the resonant circuit and the control circuit and is for coupling with the DC power source, the second switch sub-circuit is coupled with the control circuit, the primary winding is coupled with the resonant circuit, the first switch sub-circuit, the second switch sub-circuit and the secondary winding, the secondary winding is coupled with the third switch sub-circuit and the fourth switch sub-circuit, the third switch sub-circuit is coupled with the fourth switch sub-circuit and the control circuit and is for coupling with the load circuit, and the fourth switch sub-circuit is coupled with the control circuit.

Wherein, the first control signal includes a third drive signal and a fourth drive signal; the third drive signal and the fourth drive signal have opposite phases, i.e., the two have opposite level states; when the third drive signal is in the first level state, the fourth drive signal is in the second level state; when the third drive signal is in the second level state, the fourth drive signal is in the first level state.

The second control signal includes a first drive signal and a second drive signal; the first drive signal and the second drive signal have opposite phases, i.e., the two have opposite level states; when the first drive signal is in the first level state, the second drive signal is in the second level state; when the first drive signal is in the second level state, the second drive signal is in the first level state; the first drive signal and the second drive signal have the same signal frequency.

It is worth noting that in some embodiments, the first level state may be corresponding to a low level or zero level, and the second level state may be corresponding to a high level; or in some embodiments, the first level state may be corresponding to a high level, and the second level state may be corresponding to a low level or zero level. The change of the level state of the third drive signal triggers the third switch sub-circuit to change the switch state.

In some embodiments, the first AC signal also includes the first voltage signals on both ends of the primary winding, and the second AC signal includes the second voltage signals on both ends of the secondary winding, the first current signal of the third switch sub-circuit and the second current signal of the fourth switch sub-circuit.

In some embodiments, the control circuit regulates the first level state of the third drive signal PWM1 to the second level state when the first voltage signal or the second voltage signal rises, i.e., there is a rise edge in the waveform of the first voltage signal or the second voltage signal, or when the voltage change rate of the first voltage signal is higher than the first set rate, or the voltage change rate of the second voltage signal is higher than the first set rate.

S362: regulating the second level state of the third drive signal to the first level state when the first voltage signal and/or the second voltage signal drop/drops, or when the first current signal attenuates to 0 forward.

Further, the control circuit regulates the second level state of the third drive signal to the first level state when the obtained first voltage signal or the second voltage signal drops, or when the first current signal attenuates to 0 forward.

S363: regulating the first level state of the fourth drive signal to the second level state when the first voltage signal and/or the second voltage signal drop/drops.

The control circuit also regulates the first level state of the fourth drive signal to the second level state by responding to drop of the first voltage signal or the second voltage signal.

S364: regulating the second level state of the fourth drive signal to the first level state when the first voltage signal and/or the second voltage signal rise/rises, or the second current signal attenuates to 0 forward.

The control circuit regulates the second level state of the fourth drive signal to the first level state when the obtained first voltage signal and/or the second voltage signal rise/rises, i.e., there is a rise edge in the waveform of the first voltage signal or the second voltage signal, or the voltage change rate of the first voltage signal is higher than the second set rate, or the voltage change rate of the second voltage signal is higher than the second set rate; or the control circuit regulates the second level state of the fourth drive signal to the first level state when the second current signal attenuates to 0 forward.

Wherein, the change of the level state of the third drive signal triggers the third switch sub-circuit to change the switch state; the change of the level state of the fourth drive signal triggers the fourth switch sub-circuit to change the switch state to match with the switch state of the third switch sub-circuit and to regulate the second DC signal; the drop of the current to a zero cross point triggers the change of the switch state to minimize switch losses, improve efficiency and reduce electromagnetic interference.

It may be understood that in some other embodiments, the power circuit also includes some other more specific power circuits to realize other more specific control methods. Refer to FIGS. 1-6 and relevant text. No more description is made herein.

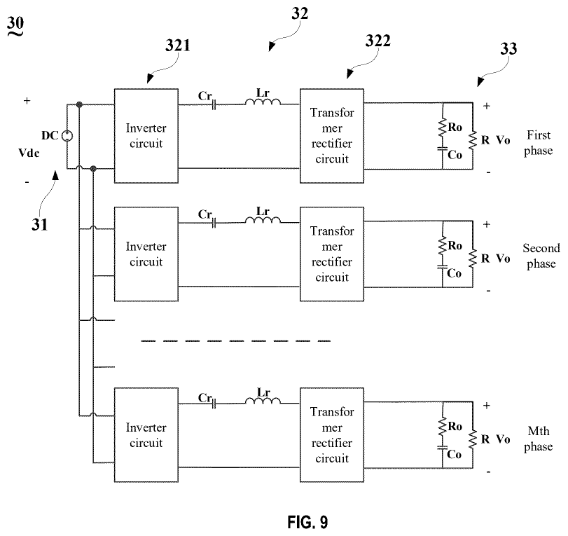

Specifically, the embodiments of this application provide a compound power circuit. Refer to FIG. 9, FIG. 9. illustrates a framework diagram of an embodiment of the compound power circuit in this application. In this embodiment, the compound power circuit 30 includes the DC power source 31 and two or more power circuits 32 which are in series or parallel connection and are coupled with the DC power source 31.

In an embodiment, the compound power circuit 30 also includes two or more filter output circuits 33, and every filter output circuit 33 is coupled with a power circuit 32 to form a first phase power circuit, a second phase power circuit, . . . the Mth (M is an integer greater than 1) phase power circuit.

Wherein, in some embodiments, the compound power circuit 30 may be formed by a plurality of hybrid circuits by series or parallel connection; wherein, the hybrid circuit is formed by two circuits formed by a plurality of the inverter circuits 321 by series or parallel connection and by two circuits formed by a plurality of the transformer rectifier circuits 322 by series or parallel connection. The control method is same with above power control method.

It should be noted that the power circuit 32 in the embodiment is power circuit 10 or power circuit 20 in any of the above embodiments. Refer to FIGS. 1-6 and relevant text. No more description is made herein.

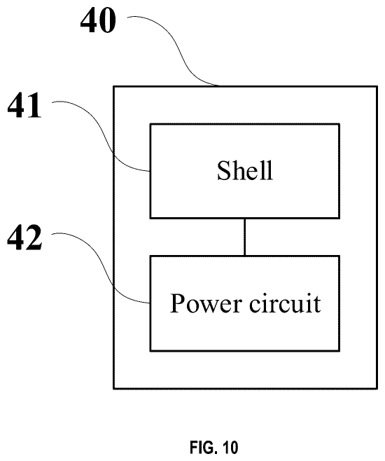

The embodiments of this application also provide an electronic device. Referring to FIG. 10, FIG. 10. illustrates a framework diagram of an embodiment of the electronic device in this application. In this embodiment, the electronic device 40 includes a shell 41 and a power circuit 42 or a compound power circuit (not marked in the drawing) connected with the shell 41.

In some embodiments, the electronic device 40 may be a server, a computer, an intelligent communication device and any other reasonable electronic devices. However, the present disclosure is not limited to the embodiments described herein.

It should be noted that the power circuit 42 in this embodiment is power circuit 10 or power circuit 20 in any of the above embodiments. Refer to FIGS. 1-6 and relevant text. No more description is made herein.

It should be noted that the compound power circuit in this embodiment is the compound power circuit 30 in any of the above embodiments. Refer to FIG. 9 and relevant text. No more description is made herein.

The beneficial effects of this application are that different from the related art, in this application, the inverter circuit of the power circuit receives the first DC signal from the DC power source and converts the first DC signal to the first AC signal, the resonant circuit regulates the first AC signal, the isolation transformer converts the regulated first AC signal to the second AC signal, and the rectifier circuit converts the second AC signal to the second DC signal and outputs the second DC signal to the load circuit; wherein, the control circuit generates the first control signal based on rise and/or drop of the first AC signal voltage and/or rise and/or drop of the second AC signal voltage, and sends the first control signal to the rectifier circuit to trigger the rectifier circuit to change the switch state under the action of the first control signal and regulate the second DC signal; the isolation transformer regulates the current of the resonant circuit. Embodiments in this application ensure the realization of the inverter circuit ZVS (Zero Voltage Switch) ON, and guarantee high efficiency and high reliability of the power circuit within the full frequency working range, effectively reducing circuit losses and switching noises, expanding the maximum gain range and improving the efficiency and power density of power circuits for wide application.

The above content is only the embodiments in this application and constitutes no limitation to the scope of the patent in this application. Any equivalent structure or equivalent process transformation made by reference of the specification and the drawings in this application, or direct or indirect application in other related technical fields are included in the protection scope of the patent of this application.

What is claimed is:

1. A power circuit, comprising:
an inverter circuit coupled with a DC power source to receive a first DC signal from the DC power source and convert the first DC signal to a first AC signal;
a resonant circuit coupled with the inverter circuit to receive and regulate the first AC signal from the inverter circuit;
an isolation transformer coupled with the resonant circuit to receive the regulated first AC signal from the resonant circuit and convert the regulated first AC signal to a second AC signal;
a rectifier circuit coupled with the isolation transformer and a load circuit to receive the second AC signal from the isolation transformer, convert the second AC signal to a second DC signal, and output the second DC signal to the load circuit; and
a control circuit coupled with the inverter circuit and the rectifier circuit to obtain at least one of the first AC signal or the second AC signal in the isolation transformer by sampling, and generate a first control signal based on at least one of rise or drop of the first AC signal voltage, or at least one of rise or drop of the second AC signal voltage, wherein
the rectifier circuit is configured to receive the first control signal and regulate the second DC signal based on the first control signal.

2. The power circuit according to claim 1, wherein:
the control circuit is configured to obtain the second DC signal in the rectifier circuit by sampling, compare the second DC signal with a preset power threshold to determine the signal frequency of a second control signal, and send the second control signal at the signal frequency; and
the inverter circuit is configured to receive the second control signal and regulate the first AC signal based on the second control signal.

3. The power circuit according to claim 2, wherein:
the inverter circuit further comprises a first switch sub-circuit and a second switch sub-circuit;
the first switch sub-circuit is coupled with the second switch sub-circuit, the resonant circuit, the isolation transformer, and the control circuit, and is coupled with the DC power source;
the second switch sub-circuit is coupled with the control circuit;
the second control signal comprises a first drive signal and a second drive signal;
the first switch sub-circuit is configured to receive the first drive signal to change a switch state of the first switch sub-circuit under an action of the first drive signal;
the second switch sub-circuit is configured to receive the second drive signal to change a switch state of the second switch sub-circuit under an action of the second drive signal to match with the switch state of the first switch sub-circuit, and regulate the first AC signal.

4. The power circuit according to claim 3, wherein:
the control circuit further comprises a sampling circuit, a signal processing circuit, and a drive circuit;
the sampling circuit is coupled with the isolation transformer and the signal processing circuit;
the signal processing circuit is coupled with the drive circuit, and
the drive circuit is coupled with the inverter circuit and the rectifier circuit;
the sampling circuit is configured to obtain at least one of the first AC signal or the second AC signal in the isolation transformer by sampling; and
the signal processing circuit is configured to receive at least one of the first AC signal or the second AC signal, control the drive circuit to change a level state of the first control signal by responding to at least one of rise or drop of the first AC signal voltage, or at least one of rise or drop of the second AC signal voltage, and send the first control signal to the rectifier circuit to trigger the rectifier circuit to change a switch state of the rectifier circuit and regulate the second DC signal.

5. The power circuit according to claim 4, wherein:
the control circuit further comprises a first proportional filtering correction circuit and a second proportional filtering correction circuit;
the sampling circuit further comprises a first sampling circuit and a second sampling circuit;
the first sampling circuit is coupled with the isolation transformer and the first proportional filtering correction circuit;
the second sampling circuit is coupled with the rectifier circuit and the second proportional filtering correction circuit;
the first sampling circuit is configured to obtain the first AC signal or the second AC signal in the isolation transformer by sampling;
the second sampling circuit is configured to obtain the second DC signal in the rectifier circuit by sampling;
the first proportional filtering correction circuit is configured to receive at least one of the first AC signal or the second AC signal, and send at least one of the first AC signal or the second AC signal to the signal processing circuit after comparison with reference value, filtration, and correction, so that the signal processing circuit is configured to control the drive circuit to generate the first control signal; and
the second proportional filtering correction circuit is configured to receive the second DC signal, and send the second DC signal to the signal processing circuit after comparison with reference value, filtration, and correction, so that the signal processing circuit is configured to control the drive circuit to generate the first drive signal and the second drive signal.

6. The power circuit according to claim 3, wherein:
the rectifier circuit further comprises a third switch sub-circuit and a fourth switch sub-circuit;
the isolation transformer further comprises a primary winding and a secondary winding;
the primary winding is coupled with the resonant circuit and the secondary winding;
the secondary winding is coupled with the third switch sub-circuit and the fourth switch sub-circuit;
the third switch sub-circuit is coupled with the fourth switch sub-circuit and the control circuit and is coupled with the load circuit;
the fourth switch sub-circuit is coupled with the control circuit;
the first control signal comprises a third drive signal and a fourth drive signal;
the primary winding is configured to receive the regulated first AC signal from the resonant circuit;
the secondary winding is configured to convert the first AC signal to the second AC signal, and send the second AC signal to the third switch sub-circuit and the fourth switch sub-circuit;
the first AC signal comprises the first voltage signals on both ends of the primary winding;
the second AC signal comprises the second voltage signals on both ends of the secondary winding;
the third switch sub-circuit is configured to receive the third drive signal from the control circuit;
the level state of the third drive signal is configured to be changed in rise and drop of the first voltage signal, or in rise and drop of the second voltage signal, to trigger the third switch sub-circuit to change a switch state of the third switch sub-circuit;
the fourth switch sub-circuit is configured to receive the fourth drive signal; and
the level state of the fourth drive signal is configured to be changed in rise and drop of the first voltage signal, or in rise and drop of the second voltage signal, to trigger the fourth switch sub-circuit to change a switch state of the fourth switch sub-circuit.

7. The power circuit according to claim 6, wherein:
the second AC signal further comprises a first current signal of the third switch sub-circuit and a second current signal of the fourth switch sub-circuit;
the control circuit is configured to regulate a first level state of the third drive signal to a second level state when at least one of the first voltage signal or the second voltage signal rises, and the control circuit is configured to regulate the second level state of the third drive signal to the first level state when at least one of the first voltage signal or the second voltage signal drops, or when the first current signal attenuates to 0 forward;
the control circuit is configured to regulate the first level state of the fourth drive signal to the second level state when at least one of the first voltage signal or the second voltage signal drops; and
the control circuit is configured to regulate the second level state of the fourth drive signal to the first level state when at least one of the first voltage signal or the second voltage signal rises, or when the second current signal attenuates to 0 forward.

8. The power circuit according to claim 7, wherein:
when the signal frequency is lower than the resonant frequency of the resonant circuit, the first drive signal is in the second level state, the second drive signal is in the first level state, the third drive signal is in the first level state, and the fourth drive signal is in the second level state; or
when the first drive signal is in the first level state, the second drive signal is in the second level state, the third drive signal is in the second level state, and the fourth drive signal is in the first level state,
wherein the phase of the third current of the resonant circuit remains unchanged.

9. The power circuit according to claim 3, wherein:
the first switch sub-circuit comprises a first switching tube and a fourth switching tube;
the second switch sub-circuit comprises a second switching tube and a third switching tube;
the first end of the first switching tube is coupled with the first end of the third switching tube and is coupled with the first end of the DC power source;
the second end of the first switching tube is coupled with the first end of the second switching tube and the first end of the resonant circuit;
the second end of the third switching tube is coupled with the first end of the fourth switching tube and the second end of the isolation transformer;
the second end of the second switching tube is coupled with the second end of the fourth switching tube and is coupled with the second end of the DC power source; and
the third ends of the first switching tube, the second switching tube, the third switching tube, and the fourth switching tube are coupled with the control output end of the control circuit; or
the first switch sub-circuit comprises a seventh switching tube;
the second switch sub-circuit comprises an eighth switching tube;
the first end of the seventh switching tube is coupled with the first end of the DC power source;
the second end of the seventh switching tube is coupled with the first end of the eighth switching tube and the first end of the resonant circuit;
the second end of the eighth switching tube is coupled with the second end of the isolation transformer and is coupled with the second end of the DC power source; and
the third end of the seventh switching tube and the third end of the eighth switching tube are coupled with the control output end of the control circuit.

10. The power circuit according to claim 6, wherein:
the secondary winding comprises a first sub secondary winding and a second sub secondary winding;
the third switch sub-circuit comprises a fifth switching tube;
the fourth switch sub-circuit comprises a sixth switching tube;
the first end of the first sub secondary winding is coupled with the first end of the fifth switching tube;
the second end of the first sub secondary winding is coupled with the second end of the second sub secondary winding and is coupled with the second end of the load circuit;
the first end of the second sub secondary winding is coupled with the first end of the sixth switching tube;
the second end of the fifth switching tube is coupled with the second end of the sixth switching tube and is coupled with the first end of the load circuit; and
the third end of the fifth switching tube and the third end of the sixth switching tube are coupled with the control output end of the control circuit; or
the third switch sub-circuit comprises a ninth switching tube and a twelfth switching tube;
the fourth switch sub-circuit comprises a tenth switching tube and an eleventh switching tube;
the first end of the secondary winding is coupled with the first end of the ninth switching tube and the second end of the tenth switching tube;
the second end of the secondary winding is coupled with the first end of the eleventh switching tube and the second end of the twelfth switching tube;
the second end of the ninth switching tube is coupled with the second end of the eleventh switching tube and is coupled with the first end of the load circuit;
the first end of the tenth switching tube is coupled with the first end of the twelfth switching tube and is coupled with the second end of the load circuit; and
the third ends of the ninth switching tube, the tenth switching tube, the eleventh switching tube, and the twelfth switching tube are coupled with the control output end of the control circuit.

11. A power control method, comprising:
receiving a first DC signal from a DC power source;
converting the first DC signal to a first AC signal;
regulating the first AC signal;
converting the regulated first AC signal to a second AC signal;
converting the second AC signal to a second DC signal and outputting the second DC signal to a load circuit;
generating a first control signal based on at least one of rise or drop of a regulated first AC signal voltage, or at least one of rise or drop of a second AC signal voltage; and
regulating the second DC signal based on the first control signal.

12. The power control method according to claim 11, wherein the converting the second AC signal to the second DC signal and outputting the second DC signal to the load circuit further comprises:
comparing the second DC signal with a preset power threshold to determine a signal frequency of a second control signal; and
regulating the first AC signal based on the second control signal.

13. The power control method according to claim 11, wherein:
the first control signal comprises a third drive signal and a fourth drive signal;
the second AC signal comprises a first voltage signal, a second voltage signal, a first current signal, and a second current signal;
the generating the first control signal based on at least one of rise or drop of the regulated first AC signal voltage, or at least one of rise or drop of the second AC signal voltage further comprises:
regulating a first level state of the third drive signal to a second level state when at least one of the first voltage signal or the second voltage signal rises;
regulating the second level state of the third drive signal to the first level state when at least one of the first voltage signal or the second voltage signal drops, or when the first current signal attenuates to 0 forward;
regulating the first level state of the fourth drive signal to the second level state when at least one of the first voltage signal or the second voltage signal drops; and
regulating the second level state of the fourth drive signal to the first level state when at least one of the first voltage signal or the second voltage signal rises, or when the second current signal attenuates to 0 forward.

14. A compound power circuit, comprising:
a DC power source; and
at least two power circuits which are in series or parallel connection and are coupled with the DC power source,
wherein the power circuit comprises:
an inverter circuit coupled with the DC power source to receive a first DC signal from the DC power source and convert the first DC signal to a first AC signal;
a resonant circuit coupled with the inverter circuit to receive and regulate the first AC signal from the inverter circuit;
an isolation transformer coupled with the resonant circuit to receive the regulated first AC signal from the resonant circuit and convert the regulated first AC signal to a second AC signal;
a rectifier circuit coupled with the isolation transformer and a load circuit to receive the second AC signal from the isolation transformer, convert the second AC signal to a second DC signal, and output the second DC signal to the load circuit; and
a control circuit coupled with the inverter circuit and the rectifier circuit to obtain at least one of the first AC signal or the second AC signal in the isolation transformer by sampling, and generate a first control signal based on at least one of rise or drop of the first AC signal voltage, or at least one of rise or drop of the second AC signal voltage,
wherein the rectifier circuit is configured to receive the first control signal and regulate the second DC signal based on the first control signal.

15. An electronic device, comprising:
a shell; and
a power circuit or a compound power circuit connected with the shell,
wherein the power circuit comprises:
an inverter circuit coupled with a DC power source to receive a first DC signal from the DC power source and convert the first DC signal to a first AC signal;
a resonant circuit coupled with the inverter circuit to receive and regulate the first AC signal from the inverter circuit;
an isolation transformer coupled with the resonant circuit to receive the regulated first AC signal from the resonant circuit and convert the regulated first AC signal to a second AC signal;
a rectifier circuit coupled with the isolation transformer and a load circuit to receive the second AC signal from the isolation transformer, convert the second AC signal to a second DC signal, and output the second DC signal to the load circuit; and
a control circuit coupled with the inverter circuit and the rectifier circuit to obtain at least one of the first AC signal or the second AC signal in the isolation transformer by sampling, and generate a first control signal based on at least one of rise or drop of the first AC signal voltage, or at least one of rise or drop of the second AC signal voltage,
wherein the rectifier circuit is configured to receive the first control signal and regulate the second DC signal based on the first control signal; and
wherein the compound power circuit comprises:
the DC power source; and
at least two of the power circuits which are in series or parallel connection and are coupled with the DC power source.
